(19) United States
(12) Patent Application Publication
(10) Pub. No.: US 2002/0160520 A1
(43) Pub. Date: Oct. 31, 2002

(54) Silicon nano-collection analytic device

(75) Inventors: Eugene Orloff, Berkeley, CA (US); Kumar Subramanian, Pleasanton, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Phoenix Bioscience, Pleasanton, CA

(21) Appl. No.: 10/099,495

(22) Filed: Mar. 13, 2002

Related U.S. Application Data
(60) Provisional application No. 60/276,763, filed on Mar. 16, 2001.

(51) Int. Cl. G01N 1/10; G01N 21/00

(52) U.S. Cl. 436/72; 436/180; 436/164; 436/165; 436/172; 436/149; 436/150; 422/55; 422/58; 422/82.01; 422/100; 422/82.05; 422/82.08; 422/82.09; 435/14; 435/288.7; 204/403.01

(57) ABSTRACT

This invention relates to a nanofabricated device for collecting and analyzing small volumes of fluid for analysis. It comprises an etched silicon device having top and bottom members which together form an inlet, analytic region and vent where the inlet has a tapered surface for ready collection of fluid.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### FIELD OF THE INVENTION

This invention relates to a nanofabricated device for collecting and analyzing small volumes of fluid for analysis. It comprises an etched silicon device having top and bottom members which together form an inlet, analytic region and vent where the inlet has a tapered surface for ready collection of fluid.

### BACKGROUND OF THE INVENTION

1. Description of Related Art

The art of fluid sampling is inundated with a wide variety of sampling methods and instruments. The scope of liquids analyzed varies among industrial chemicals, water, pesticides, drugs and controlled substances, and body fluids such as blood interstitial fluid and urine. Typically, the fluids being analyzed are placed in contact with a reagent test strip, resulting in a qualitatively measurable color change.

In recent years there has been a growing need to equip the common individual to perform biological fluid testing at home or during normal day-to-day routines without having to visit their physician. Several types of instruments have been developed along the lines of home pregnancy testers, hemoglobin testers, and blood glucose testers for diabetics.

Diabetes mellitus is a chronic disease that affects more than 15 million Americans. About seventy five percent of these are type II (non-insulin dependent). Accurate blood glucose monitoring is imperative for proper management of blood sugar levels for diabetics. Several systems have been developed over the recent years permitting home testing of blood sugar levels. Most of these systems require the user to draw a blood sample usually from the fingertip and deliver the blood sample to a collection device in the form of a capillary and reservoir with predisposed reagents for analysis. Due the sensitivity of the fingertips however, testing is quite painful and even traumatic for many users, especially among children and infants. Recently devices have been developed which sample body fluid from the forearm as a means of drawing body fluid painlessly, U.S. Pat. Nos. D 0,427,312, U.S. 06,120,676, U.S.D 0,426,638, U.S.D 0,424,696. However, obtaining the volume of blood required for these systems from the forearm has been difficult.

A prevalent shortcoming of the current art is that the methods and instruments designed for body fluid sampling require two distinctly different steps: a lancing step and a filling step, which requires manual delivery of a relatively large volume of body fluid to the collection device. The proper delivery of the blood to the collection device often requires a good deal of manual dexterity and is quite difficult for older diabetics, and individuals with failing eyesight. Often the blood drop ends up smeared along the collection device or on the users themselves, creating a mess and a failed test. As a result tests often need to be repeated several times until the procedure is performed properly.

The designs of the fluid collection devices used in the current art vary greatly. The ONE TOUCH ™ by Lifescan uses a reagent coated test strip where a drop of blood is placed in an exposed collection area. The blood reacts with the glucose to form a color change that is read optically by a meter, the results are then displayed for the user. Proper delivery of the blood sample to the collection area is difficult to perform. Furthermore, in this system since the blood is delivered as a drop from the fingertip, proper volume control is nonexistent.

Many collection devices presented in the current art are formed on a plastic substrate with molded channels, grooves or slots to create a fluid capillary and collection area. Chemical reagents for producing colorimetric or electrochemical reactions are deposited in the collection area. Usually the plastic substrate is covered with a second plastic strip, and the two are sealed together using adhesives.

One common test device, U.S. Pat. No. 5674457, assigned to Hemocue, describes an integral capillary microcuvette comprising a body member and a cavity including a measuring zone within the body member. The cavity is defined by two opposite, substantially parallel inner surfaces of the body member and includes an outer peripheral edge comprising a sample inlet and an inner peripheral zone having a channel of higher capillary force than the measuring zone. The channel extends around the entire inner peripheral zone with ends of the channel communicating with the atmosphere at the exterior of the microcuvette. In this device a blood drop is delivered to the side of the microcuvette. The channel of higher capillarity draws blood in faster than measuring zone as a means of eliminating air bubble formation in the measuring zone. The blood then flows outward towards the opening. This system still requires manual delivery of the sample to the collection device as well as requires a large volume.

Another typical test device is described by Hillman et al., U.S. Pat. No. 4,756,884, this application describes methods and devices involving at least one chamber, at least one capillary, and at least one reagent involved in a system providing a detectable signal. Also, Vogel et al., U.S. Pat. No. 4,582,684, describes a cuvette for the determination of a chemical component of a fluid by photo evaluation. The device uses two planar shaped parts parallel to one another at least one of which is transparent. A filamentary piece is placed between the planar shaped parts for receiving the fluid and setting the spacing between the planar shaped parts. The planar shaped parts are sealed together using adhesives.

Another device, Hill et al., U.S. Pat. No. 5,975,153, describes an improved capillary fill device. The device is formed having a capillary aperture designed and sized to facilitate filling of the device. Several drawings illustrate the device inlet. The enlarged capillary inlet is intended to provide a larger target area for fluid delivery, making manual blood delivery easier in the case of a finger prick. A fabrication technique for forming internal chambers in plastic devices is also described.

Also, Meserol and Palmieri, U.S. Pat. No. 4,873,993, describes a cuvette with or without a lancet secured to the cuvette for producing a skin puncture to produce body fluid. The cuvette is made of optically transparent material and is housed within an instrument, U.S. Pat. No. 5,029,583, for conducting a measurement. The cuvette is integrated with several optical elements which allow light to enter the cuvette, bounce off the optical elements through total internal reflection, and exit the cuvette. Body fluid is applied to the cuvette by manually wiping across an inlet area.

Many of the afore mentioned devices have in common that the cuvettes and capillaries for collecting a body fluid sample are constructed using at least one or more plastic parts. The capillary channel, which sets the cuvette depth and volume, as well as the optical path for devices using optical analysis, is often controlled by plastic injection molding. It is difficult to hold the tolerances required for repeatable and precise control of the capillary channel in plastics. The accuracy of the measurement is highly dependent on the uniformity of the cuvette depth.

Another body fluid sampling device by, Smart and Subramanian, U.S. Pat. No. 5,801,057, describes a silicon microsampler. The silicon microsampler is a microchamber forming a cuvette with an integrated hollow silicon needle. The microchamber and needle are formed from one silicon substrate through a series of etching processes. The microchamber and microneedle of the microsampler are covered with a glass layer that is anodically bonded to the silicon portion.

### BRIEF SUMMARY OF THE INVENTION

The present invention is a silicon nano-collection analytic device, referred to as the nanocuvette, having an inlet, an analysis region, a vent and a signal path. The nanocuvette is formed from a distinct bottom and top member. The bottom member is silicon and has a proximal end, a distal end and an etched region disposed between the proximal and distal ends. The etched region has an inlet portion, an analytic portion, and a vent portion with the inlet portion located at the proximal end, the vent portion located at the distal end and the analytic portion disposed between the inlet and vent portions. One embodiment of the present invention allows for the proximal end to be tapered.

The nanocuvette top member is dimensionally mated to the bottom member so that the analysis portion is sealed to yield an analysis region defining the interior of the device. The inlet and vent are created with the analysis region in fluid communication with the inlet and vent. The nanocuvette members provide a signal path for communicating the state of the analysis from the interior of the device to the exterior. The signal path may be optical through an optically transparent top member or window, or electrical through electrodes deposited on either member.

Several embodiments are discussed for the members of the nanocuvette. In one embodiment, the signal path is a top member that is optically transparent. In another embodiment, the signal path is both a top member that is optically transparent and a bottom member with an optically transparent window. In both cases, the top member may be constructed from materials including but not limited to glass and plastic. The optical window in the bottom member may be formed from thin films including but not limited to silicon nitride, silicon oxide and polyimide. In yet another embodiment of the present invention the signal path comprises a pair of electrodes deposited on either the top or bottom member. In this embodiment the top member may be formed from silicon. Either the bottom or top member may contain a contact pad region at the distal end.

Other embodiments of the present invention allow for a device wherein either the top member or the etched region of the bottom member comprises either chemical reagents or an electrochemical sensor for analyzing biological samples.

In the present invention the inlet is at least 15-200 microns in one dimension, the vent region is at least 100-500 microns in one dimension. The etched region of the bottom member is 20-150 microns deep, with a volume of 50 to 300 nanoliters.

The present invention also describes a process for manufacturing a silicon nano-collection analytic device having an inlet, an analysis region, a vent and a signal path for communicating from the interior of the analysis region to the exterior. The device is formed from a distinct bottom and top member with a process comprising: 1. Etching into silicon to form a bottom member having a proximal end, a vent portion in the distal end, an inlet portion in the proximal end, and an analysis region disposed between the vent portion and inlet portion; 2. Contacting the bottom member with the top member where the top member is dimensionally mated to the bottom member to form the inlet and vent, and to seal the analysis portion to yield the analysis region defining an interior with a signal path.

Other embodiments of the present invention allow for methods wherein: dry etching forms a taper at the proximal end of either the top, bottom or both top and bottom members; molding or grinding forms a taper at the proximal end of the top member; wet etching forms a taper at a 54.7° at the proximal end of either the top, bottom or both top and bottom members.

The present invention also allows for a method of determining the presence of analytes in a silicon nano-collection analytic device comprising: introducing fluid containing analytes into the inlet; permitting the fluid to enter the analysis region; and, communicating the state of the analysis via the signal pathway.

Several types of fluid that may be analyzed include but are not limited to blood, interstitial fluid, or a combination of blood and interstitial fluid. The present invention allows for various detection methods including but not limited to reflectance, transmittance, electrochemical, fluorescence, or chemiluminescence. The preferred analyte of the present invention is glucose.

### BRIEF DESCRIPTION OF THE DRAWINGS

FIG. 1 is a plan view showing the device in one embodiment from the side.

FIG. 2 is an exploded perspective view showing the top member bottom member and the etched region of the bottom member.

FIG. 3 is a plan view showing the inner surface of the top member and illustrating contact pads and an electrochemical sensor from above.

FIG. 4 is a plan view illustrating the signal path through the top member.

FIG. 5 is a plan view showing the bottom member with an optical window in the etched region.

FIG. 6 is a plan view illustrating the signal path through the top and bottom members.

### DETAILED DESCRIPTION OF THE INVENTION

The present invention is a nano-collection analytic device having an inlet, and analysis region, a vent and a signal path for communicating the state of the analysis from the device interior to the exterior. The nanocuvette is constructed from two distinctly different pieces: a top member and a bottom member. The nanocuvette bottom member is constructed from a silicon wafer; the top member may be constructed from silicon glass or plastic. The nanocuvette, depending on the specific embodiment, may be designed to use several different analysis techniques to detect analytes in body fluid. Some of the more common methods are reflectance assays, transmittance assays and electrochemical assays.

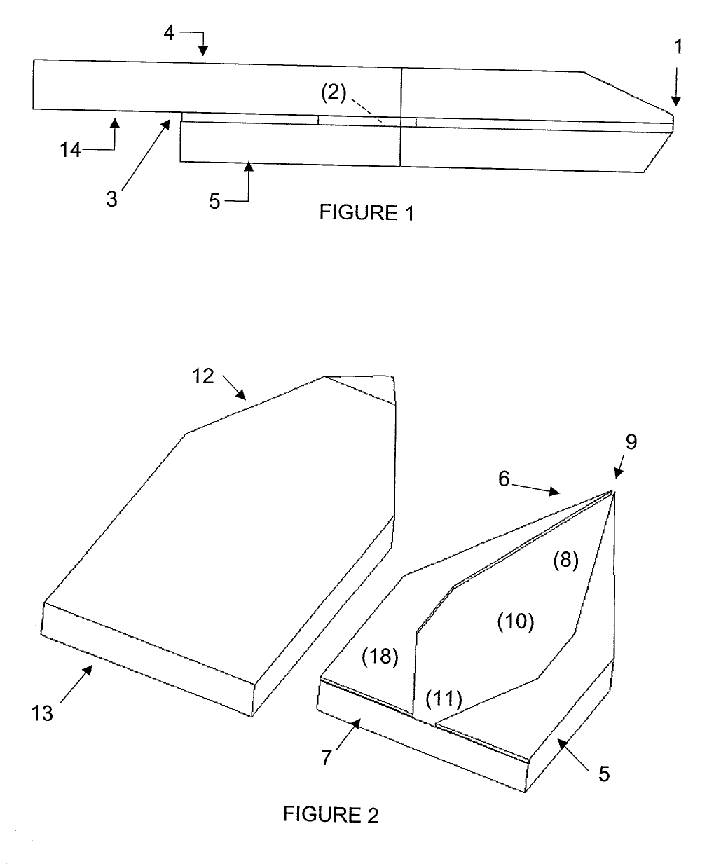

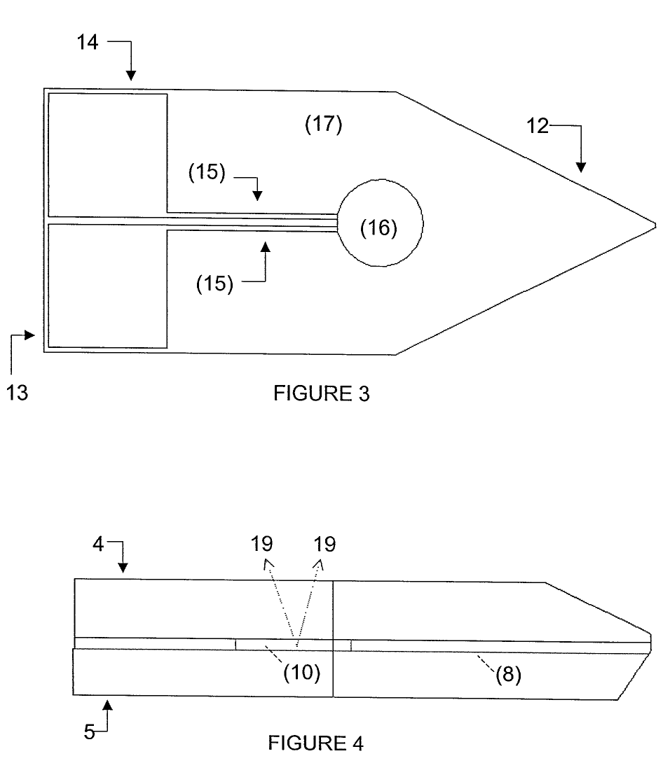

The preferred embodiment of the nanocuvette is shown in FIGS. 1-3. In this embodiment the nanocuvette is designed for use with an electrochemical analysis. FIG. 1 shows the nanocuvette in side view. This figure illustrates the inlet (1), the analysis region (2), and the vent (3). The nanocuvette is formed by combining both the top member (4) and the bottom member (5).

FIG. 2 shows an exploded perspective view of the nanocuvette. In this view the bottom member (5) is well illustrated. The bottom member (5) is fabricated from silicon and has a proximal end (6), a distal end (7) and an etched region (8) forming a capillary channel disposed between the proximal and distal ends. The etched region (8) has an inlet portion (9), an analytic portion (10), and a vent portion (11). The bottom member (5) may range in size from 3 mm-8 mm in length (preferred 3 mm), 1 mm-5 mm wide at the distal end (7) (preferred 2 mm), 50 μm-5 mm wide at the proximal end (6), and 100 μm-1 mm thick. The etched region (8) may vary from 20 μm-150 μm deep, 15 μm-200 μm wide at the inlet portion (9), 500 μm-2 mm wide at the analytic portion (10), and 100 μm-500 μm wide at the vent portion (11). The preferred body dimensions for the bottom member (5) are 3 mm long, 2 mm wide at the distal end (7), 50 μm wide at the proximal end (6), and 350 μm thick. The preferred dimensions for the etched region (8) are 50 μm deep, 30 μm wide at the inlet portion (9), 1 mm wide at the analytic portion (10), and 200 μm wide at the vent portion (11).

The silicon bottom member (5) and the etched region (8) may be processed using common silicon microfabrication techniques, such as a plasma photolithographic etching process. The silicon bottom member (5) and the etched region (8) are patterned and etched in arrays on standard silicon wafers. In this embodiment the bottom member (5) is not being used as an insulating medium, therefore the doping levels of the silicon are irrelevant. The silicon will preferably be [100] oriented single crystal.

The first step in forming the bottom member is to spin coat photoresist on the front side of the silicon wafer. A photomask with a patterned array of the capillary channel and dicing grooves defining the bottom member outer body dimensions is placed over the spin-coated wafer. The wafer is then exposed to UV radiation creating the patterned array in the photoresist. The wafer is then plasma etched in a high rate plasma etcher. During this process silicon is removed from the area defining the capillary channel and the outer body dimension. The wafer is etched until the capillary channel reaches the desired depth, preferably 50 μm. Once removed from the plasma etcher the remaining photoresist may be removed either chemically or by placing the wafer in a furnace at 750° C. for 15 minutes. The individual bottom members may be separated from the wafer and each other by “snapping” them off or dicing them along the dicing grooves that define the outer body dimensions. Prior to dicing, the wafer may be additionally processed to form dicing grooves along the backside of the wafer, which are aligned to the dicing grooves on the front side of the wafer, to facilitate easier removal of the bottom members.

Although the preferred method of creating the dicing grooves is via plasma etching other etchants such as potassium hydroxide (KOH) may be used. The steps for KOH etching the dicing grooves are similar to those described for plasma etching and are well known to those skilled in the art.

FIGS. 1-3 well illustrate the top member (4) of the nanocuvette in the present embodiment. The top member (4) may be fabricated from silicon, glass, plastic, ceramic or any other appropriate material of the like; the preferred material is silicon sufficiently doped to act as an insulating medium. The top member (4) has a proximal end (12), a distal end (13), and a contact pad region (14) located at the distal end. The top member is also equipped with electrodes (15) and an electrochemical sensor (16). The top member (4) may range in size from 3 mm-8 mm in length, 1 mm-5 mm wide at the distal end (13), 50 μm-5 mm wide at the proximal end (12), and 100 μm-1 mm thick. The preferred body dimensions for the top member (4) are 3 mm long, 2 mm wide at the distal end (13), 50 μm wide at the proximal end (12), and 350 μm thick.

The contact pad region (14) is a portion of the top member (4) that extends beyond the vent portion (11) at the distal end (7) of the bottom member (5) when the two members are placed together. The contact pad region (14) is sufficiently large to contain the electrodes (15) and allow them to expand in area, permitting easy physical contact with corresponding electrodes of an external instrument. The contact pad region (14) may vary in size from 1 mm-5 mm wide at the distal end (13), and 1 mm-3 mm in length. The preferred dimensions of the contact pad region (14) are 2 mm wide at the distal end (13) and 1.5 mm in length.

The electrodes (15) are conducting traces deposited on the inner surface (17) of the top member (4). The electrodes (15) act as a signal pathway for communicating the results of an electrochemical reaction from an electrochemical sensor (16) between the nanocuvette interior to the exterior. The electrodes may be made from any noble metal: primarily gold, platinum or silver. The metal electrodes can be deposited on a silicon, plastic or glass substrate either by sputtering or by evaporation in a vacuum chamber. Sputtering is the preferred method of deposition of metals. The metal deposited substrate will be coated with a thin layer of photoresist. The photoresist will then be exposed and patterned with exposure to UV light. The metal can then be etched with a reagent to create the specific metal trace patterns.

The top member (4) is processed by first spin coating the backside of the wafer with photoresist. The photoresist is then patterned and exposed with a photomask containing the dicing groove patterns that will define the size and dimensions of the top members. The wafer is then etched in a high rate plasma etcher creating dicing grooves at a depth convenient for dicing individual top members. Dicing grooves may also be formed from a similar KOH etching process. The electrodes (15) may then be deposited on the front side of the wafer using conventional methods. These consist of but are not limited to evaporation, sputtering or chemical etching. The electrodes (15) are patterned such that they originate in the area of the top member (4) that is adjacent to the analytic portion (10) of the bottom member (5) when the two members are combined. The electrodes (15) run along the top member (4) and expand in size terminating in the contact pad region (14). An electrochemical sensor (16) is then formed on the top member (4) in appropriate contact with the electrodes (15) in the area of the top member (4) that is adjacent to the analytic portion (10) of the bottom member (5) when the two members are combined. Glucose biosensors are based on the fact that the enzyme glucose oxidase catalyses the oxidation of glucose to gluconic acid. The first generation glucose biosensors used molecular oxygen as the oxidizing agent. Commercially available finger stick glucose devices use a ferrocene based mediator system in lieu of molecular oxygen. Recently, immobilization techniques have been developed to “wire” an enzyme directly to an electrode, facilitating rapid electron transfer and hence high current densities. The electrochemical sensor (16) is approximately 1-2 mm in diameter and may be constructed using ink jet printing technologies with the appropriate reagents and enzymatic solutions.

The top members may be separated from the wafer and adjacent top members by dicing along the dicing grooves. Placing the top member inner surface (17) onto the bottom member inner surface (18) and aligning the corresponding outer edges forms the nanocuvette. The top member (4) is required to be dimensionally mated to the bottom member (5), having external body shape and dimensions similar to that of the bottom member (5) such that critical edges of the two distinct pieces align when placed on top of one another. This forms a fluid seal between the two members. Joining the top and bottom members forms a fluid barrier, covers the etched region (8) of the bottom member (5), and creates a capillary channel having the ability to direct fluid along the device interior. The fluid seal between the top member (4) and bottom member (5) may be created using mechanical pressure, sonic welding of plastics, glass to silicon anodic bonding, or adhesives.

In another embodiment of the invention the nanocuvette may be designed for use with a reflectance assay. In this application the bottom member (5) as shown in FIGS. 1-4 may be constructed identically with the same embodiments and dimensions as described for the electrochemical application above.

Referring to FIG. 2, in this embodiment chemical reagents are dispensed and dried or deposited in the analytic portion (10) of the etched region (8) in the bottom member (5) prior to joining the top and bottom members. The chemical reagents dispensed are dependent on the analytes to be measured in the nanocuvette. Constituents present in the body fluid that may be measured are primarily blood glucose and hemoglobin. Other analytes may include but are not limited to blood gases, controlled substances such as drugs of abuse, pesticides or other industrial chemicals. Alternative embodiments may involve depositing the reagents on the top member.

FIG. 4 shows the nanocuvette from the side view in the embodiment for use in a reflectance assay system. In this embodiment the nanocuvette top member (4) may be formed of an appropriate optically transparent material. The top member (4) will not appreciably block radiation in the desired wavelength range, 600-900 nm. Appropriate materials may be either glass or plastic. Top members (4) are constructed by either glass or plastic molding, cutting or grinding, or chemically etching. The inner surfaces may be chemically treated to enhance wettability properties with detergents, and other surfactants.

Referring to FIG. 4, the top member (4) is required to be dimensionally mated to the bottom member (5), forming a fluid seal between the two members when joined as previously described. However, in this embodiment, joining the top and bottom members provides an optical signal path (19) for communicating the state of the analysis from the interior of the device to the exterior. In this embodiment the signal path (19) is in through the top member (4), through the body fluid in the analytic portion (10) of the bottom member (5) to the surface of the etched region (8) in the bottom member (5), back through the body fluid in the analytic portion (10) of the bottom member (5), and out through the top member (4) to the outside of the device.

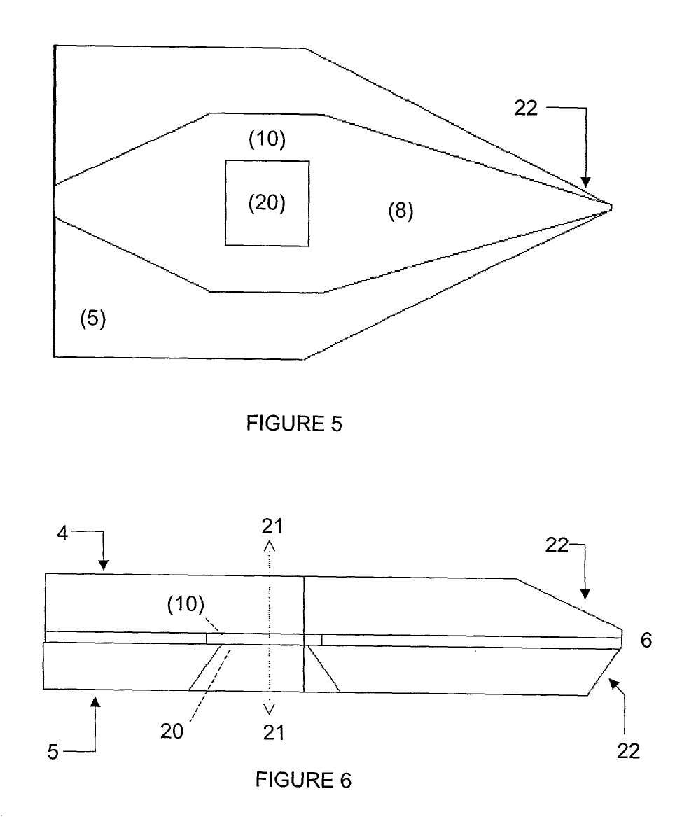

In another embodiment of the invention the nanocuvette may be designed for use with an optical transmittance assay. Referring to FIGS. 5-6, in this application the bottom member (5) may be constructed similarly with the same embodiments and dimensions as described for the electrochemical and reflectance application above. However, in this embodiment the bottom member (5) additionally includes an optically transparent window (20). The optically transparent window (20) may be formed from various thin films including but not limited to silicon nitride, silicon oxide, and polyimide. The film may have a thickness in the range from 2-5 μm.

After forming the bottom member (5) dicing grooves and capillary channel as described above, the optically transparent window (20) may be formed using the following steps. An appropriate thin film, preferably silicon nitride, is grown on the front side of the wafer using steps known to those skilled in the art. The nitride film will uniformly coat the surface of the etched region (8). Next, the backside of the wafer is spin coated with photoresist, patterned and exposed with the appropriate photomask. In this embodiment the photomask is patterned with the transparent optical window geometry. The window patterns are square in shape and located opposite the analytic portion (10) of the etched region (8) of the bottom member (5). The backside is then KOH etched, to create the optically transparent window (20). As the window pattern is KOH etched silicon is removed along the [111] crystallographic plane. This occurs at a 54.7° angle from the backside, creating a tapering square hole with its area decreasing towards the front side of the wafer. The KOH etch is allowed to run until the square hole reaches the silicon nitride thin film in the etched region (8) of the bottom member (5). The silicon nitride acts as an etch stop to the KOH, thus forming an optically clear window at the analytic portion (10) of the etched region (8) of the bottom member (5). The window pattern is dimensioned to allow for a window opening approximately 0.75-2.0 μm square (preferred 1 mm) at the surface of the etched region (8).

Referring to FIG. 6 the top member (4) may be formed of an appropriate optically transparent material. The top member (4) will not appreciably block radiation in the desired wavelength range, 600-900 nm. Appropriate top member materials may be either glass or plastic. Top members are constructed by either glass or plastic molding, cutting or grinding, or chemically etching. The inner surfaces may be chemically treated to enhance wettability properties.

Referring to FIG. 6, the top member (4) is required to be dimensionally mated to the bottom member (5), forming a fluid seal between the two members when joined as previously described. However, in this embodiment, joining the top and bottom members provides an optical signal path (21) for communicating the state of the analysis from the interior of the device to the exterior. In this embodiment the signal path (21) is in through the top member (4), through the body fluid in the analytic portion (10) of the bottom member (5), and out through the optically transparent window (20) to the outside of the device.

In another embodiment of the present invention either or both the nanocuvette top member (4) or bottom member (5) may have one or more tapered surfaces, decreasing in cross sectional area toward the fluid inlet. The tapered surfaces may be identified from both or either the top or side views. Referring to FIG. 6, on silicon members the tapered surface (22) is at a 54.7° angle towards the proximal end (6). This taper is formed during a KOH etch from the backside of the silicon wafer. Referring to FIG. (5), the tapered surface (22) may be formed from plasma etching the dicing grooves that define the member outer body dimensions as previously described. Referring to FIG. (6), on non-silicon members such as glass or plastic top members (4), the tapered surface (22) may be at an determined angle and may be formed during a molding or cutting process.

### Methods of Using

This invention is intended to provide a disposable nanocuvette for use in a one-step collection and analysis of small volumes of fluid. Fluids to be analyzed may include but are not limited to industrial chemicals, pesticides, gases, petroleum, controlled drugs, and body fluids such as blood and interstitial fluid. The present invention provides a device that is easy to fill, using capillary forces. The design of the present invention is well suited for adaptation and use in either optical or electrochemical analysis systems. The present invention incorporates a signal pathway into the nanocuvette for communication of analysis results. The present invention is also well suited for use in a hand-held instrument containing an actuation, loading and ejecting system capable of performing the necessary operations, requiring minimal manipulation from the user.

The nanocuvette is preferably used for the collection and analysis of body fluids. In this embodiment the analytes of interest may include but are not limited to blood glucose. In this embodiment the nanocuvette is used with an instrument capable of both lancing the user and automatically placing the nanocuvette at the lance site for filling with body fluid.

One of the most critical shortcomings of the current art is that the methods and instruments designed for body fluid sampling require two distinctly different steps: a lancing step and a filling step, which requires manual delivery of a relatively large volume of body fluid to the collection device. This two-step manual system is a very inaccurate, painful and messy method of delivering the test fluid to the collection device. Lancets need to be large to draw the required amount of blood. This causes pain for the user. A good degree of dexterity is required to accurately deliver the blood to the collection device; as a result it is often done improperly, requiring additional lances.

For the collection and analysis of body fluid the nanocuvette of the present invention is used with a metal penetration member sized to penetrate the skin to a determined depth necessary to urge body fluid to well to the skin surface. In one embodiment the nanocuvette and penetration member may be attached loosely by means of a hinging or sliding mechanism. In other embodiments the penetration may be attached rigidly to the nanocuvette such as imbedded in a plastic package containing both the nanocuvette and the penetration member. In yet other embodiments the nanocuvette and the penetration member may be separate from one another and controlled individually by a hand held instrument.

In this embodiment the hand held instrument utilizes an actuating system that will manipulate both the metal penetration member and the nanocuvette inside the instrument. The instrument is laid upon the user's skin; the penetration member lances the skin causing a drop of body fluid to be formed. The instrument then automatically places the nanocuvette fluid inlet into the body fluid drawing it in rapidly for analysis. A system in which both the lance and fill are automatic has far greater accuracy in filling than when done manually. Greater accuracy results in lower volume requirements from the lance and collection device, smaller lancet sizes, less pain and trauma for the user, and fewer if any failed tests.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A silicon nano-collection analytic device having an inlet, an analysis region, a vent and a signal path said device formed from a distinct bottom and top member:
wherein the bottom member is silicon and has a proximal end, a distal end and an etched region disposed between the proximal and distal ends,
where the etched region has an inlet portion, an analytic portion, and a vent portion with the inlet portion located at the proximal end, the vent portion located at the distal end and the analytic portion disposed between the inlet and vent portions;
wherein the top member is dimensionally mated to the bottom member so that the analysis portion is sealed to yield an analysis region defining the interior of the device, the inlet and vent are created with the analysis region in fluid communication with the inlet and vent, and the members provide a signal path for communicating the state of the analysis from the interior of the device to the exterior.

2. A device of claim 1 wherein the signal path is a top member that is optically transparent.

3. A device of claim 1 wherein the top member is glass.

4. A device of claim 1 wherein the top member is plastic.

5. A device of claim 1 wherein the signal path is both a top member that is optically transparent and a bottom member with an optically transparent window.

6. A device of claim 1 wherein the optical window in the bottom member is silicon nitride.

7. A device of claim 1 wherein the signal path comprises a pair of electrodes deposited on either the top or bottom member.

8. A device of claim 1 wherein the top member is silicon.

9. A device of claim 1 wherein the etched region comprises chemical reagents for analyzing biological samples.

10. A device of claim 1 wherein the etched region contains an electrochemical sensor for analyzing biological samples.

11. A device of claim 1 wherein the inlet is at least 15-200 microns in one dimension.

12. A device of claim 1 wherein the vent region is at least 100-500 microns in one dimension.

13. A device of claim 1 wherein the etched region of the bottom member is 20-150 microns deep.

14. A device of claim 1 wherein the volume of the etched region is 50 to 300 nanoliters.

15. A device of claim 1 where the proximal end is tapered.

16. A device of claim 1 wherein either the bottom or top member contains a contact pad region at the distal end.

17. A process for manufacturing a silicon nano-collection analytic device having an inlet, an analysis region, a vent and a signal path for communicating from the interior of the analysis region to the exterior said device formed from a distinct bottom and top member wherein the process comprises:
etching into silicon to form a bottom member having a proximal end, a vent portion in the distal end, an inlet portion in the proximal end, and an analysis region disposed between the vent portion and inlet portion end,
contacting the bottom member with the top member where the top member is dimensionally mated to the bottom member to form the inlet and vent, and to seal the analysis portion to yield the analysis region defining an interior with a signal path.

18. A method of claim 17 wherein the signal path is an optically transparent top member.

19. A method of claim 17 wherein the top member is glass.

20. A method of claim 17 wherein the top member is plastic.

21. A method of claim 17 wherein the signal path is both a top member that is optically transparent and a bottom member with an optically transparent window.

22. A method of claim 17 wherein the optical window in the bottom member is silicon nitride.

23. A method of claim 17 further comprising a pair of electrodes deposited on either the top or bottom member.

24. A method of claim 17 wherein the top member is silicon.

25. A method of claim 17 wherein the inlet is at least 15-200 microns in one dimension.

26. A method of claim 17 wherein the vent region is at least 100-500 microns in one dimension.

27. A method of claim 17 wherein the etched region of the bottom member is 20-150 microns deep.

28. A method of claim 17 wherein the volume of the etched region is 50 to 300 nanoliters.

29. A method of claim 17 wherein etching into the bottom member forms a contact pad area at the distal end.

30. A method of claim 17 wherein the top member contains a contact pad area at the distal end.

31. A method of claim 17 wherein dry etching forms a taper at the proximal end of either the top, bottom or both top and bottom members.

32. A method of claim 17 wherein molding or grinding forms a taper at the proximal end of the top member.

33. A method of claim 17 wherein wet etching forms a taper at a 54.7° at the proximal end of either the top, bottom or both top and bottom members.

34. A method of determining the presence of analytes in a silicon nano-collection analytic device comprising:
i. providing a silicon nano-collection analytic device having an inlet, an analysis region, a vent and a signal path said device formed from a distinct bottom and upper member:
wherein the bottom member is silicon and has a proximal end, a distal end and an etched region disposed between the proximal and distal ends,
where the etched region has an inlet portion, an analytic portion, and a vent portion with the inlet portion located at the proximal end, the vent portion located at the distal end and the analytic portion disposed between the inlet and vent portions;
wherein the top member is dimensionally mated to the bottom member so that the analysis portion is sealed to yield an analysis region defining the interior of the device, the inlet and vent are created with the analysis region in fluid communication with the inlet and vent, and the members provide a signal path for communicating the state of the analysis from the interior of the device to the exterior.
ii. introducing fluid containing analytes into the inlet;
iii. permitting the fluid to enter the analysis region; and,
iv. communicating the state of the analysis via the signal pathway.

35. A method of claim 34 wherein the fluid is blood.

36. A method of claim 34 wherein the fluid is interstitial fluid.

37. A method of claim 34 wherein the fluid is a combination of blood and interstitial fluid.

38. A method of claim 34 wherein the signal pathway is an optically transparent upper member.

39. A method of claim 34 wherein the detection method is reflectance.

40. A method of claim 34 wherein the detection method is transmittance.

41. A method of claim 34 wherein the detection method is electrochemical.

42. A method of claim 34 wherein the detection method is fluorescence.

43. A method of claim 34 wherein the detection method is chemiluminescence.

44. A method of claim 34 wherein the analyte is glucose.
